(19) United States
(12) Patent Application Publication
(10) Pub. No.: US 2019/0190025 A1
(43) Pub. Date: Jun. 20, 2019

(54) POSITIVE ELECTRODE ACTIVE MATERIAL FOR SODIUM ION SECONDARY BATTERIES

(71) Applicants: Tanaka Chemical Corporation, Fukui-shi, Fukui (JP); TOYOTA JIDOSHA KABUSHIKI KAISHA, Aichi (JP)

(72) Inventors: Mikio Hata, Fukui-shi, Fukui (JP); Taiki Yasuda, Fukui-shi, Fukui (JP); Shigeki Sato, Toyota-shi, Aichi (JP); Makio Kon, Toyota-shi, Aichi (JP)

(21) Appl. No.: 16/327,730

(22) PCT Filed: Aug. 29, 2017
(86) PCT No.: PCT/JP2017/030836

§ 371 Date: Feb. 22, 2019

(30) Foreign Application Priority Data
Aug. 29, 2016 (JP) 2016-166725

(51) Int. Cl. H01M 4/525; H01M 10/054

(52) U.S. Cl. CPC H01M 4/525; H01M 2004/028; H01M 10/054

(57) ABSTRACT

The present disclosure provides a positive electrode active material for sodium ion secondary batteries which has an excellent charge/discharge capacity and can reduce production costs The positive electrode active material for sodium ion secondary batteries comprises an oxyhydroxide containing: Ni or Ni and at least one transition metal element selected from the group consisting of Mg, Mn, Zn, Co and Al; Na; and S.

### CROSS-REFERENCE TO RELATED APPLICATION

The present application is a continuation of International Patent Application No. PCT/JP2017/030836, filed on Aug. 29, 2017, which in turn claims priority to Japanese Patent Application No. 2016-166725, filed on Aug. 29, 2016.

### BACKGROUND OF THE DISCLOSURE

### 1. Field of the Disclosure

The present disclosure relates to a positive electrode active material for sodium ion secondary batteries having an excellent charge/discharge capacity, a positive electrode for sodium ion secondary batteries comprising the positive electrode active material for sodium ion secondary batteries, and a sodium ion secondary battery comprising the positive electrode for sodium ion secondary batteries.

### 2. Discussion of the Related Art

In recent years, lithium ion secondary batteries have been put to practical use in a variety of fields. In the long term, concerns have arisen regarding the stable securement of lithium as a rare metal element. Then, the practical use of a sodium ion secondary battery using sodium existing in abundance as a resource has attracted attention.

There is an increasing demand for an excellent charge/discharge capacity also in the sodium ion secondary battery as well as the other secondary batteries. Meanwhile, from the viewpoints of reduction in production costs and a simple production method, a novel positive electrode active material used for the sodium ion secondary battery has been demanded.

As described in International Patent Application Publication No. WO 2009/099061, a composite metal oxide is proposed which contains Na, Mn, and M¹ (wherein M¹ is Fe or Ni) as the positive electrode active material for sodium ion secondary batteries, wherein the molar ratio of Na:Mn:M¹ is a:(1-b):b (wherein a is a value falling within the range of more than 0.5 and less than 1, and b is a value falling within the range of 0.001 or more and 0.5 or less.) (Patent Literature 1). The composite metal oxide of Patent Literature 1 makes it necessary to weigh and mix metal-containing compounds containing corresponding metal elements to obtain a predetermined composition, and then fire the obtained mixture under the firing conditions of 600 to 1600° C. and 0.5 to 100 hours, to improve the crystallinity.

The firing step requires setting a firing furnace, and furthermore, a long period of time is required for managing the firing conditions and firing, which disadvantageously causes high production costs and a complicated production step.

### SUMMARY OF THE DISCLOSURE

In view of the situation, an object of the present disclosure is to provide a positive electrode active material for sodium ion secondary batteries which has an excellent charge/discharge capacity and can reduce production costs while being produced by an easy method.

An aspect of the present disclosure is a positive electrode active material for sodium ion secondary batteries, characterized by comprising an oxyhydroxide containing: Ni or Ni and at least one transition metal element selected from the group consisting of Mg, Mn, Zn, Co and Al; Na; and S.

In the aspect, the positive electrode active material for sodium ion secondary batteries comprises the oxyhydroxide containing the transition metal element and the sodium element as a main component. In the aspect, examples of the oxyhydroxide include an oxyhydroxide containing Ni, Na, and S, and an oxyhydroxide containing: Ni and at least one transition metal element selected from the group consisting of Mg, Mn, Zn, Co and Al; Na; and S.

An aspect of the present disclosure is the positive electrode active material for sodium ion secondary batteries, characterized in that a content of S is 0.05 to 0.4% by mass.

An aspect of the present disclosure is the positive electrode active material for sodium ion secondary batteries, characterized in that 80% by mass or more of the oxyhydroxide is comprised.

An aspect of the present disclosure is the positive electrode active material for sodium ion secondary batteries, characterized in that the oxyhydroxide is a hydroxide containing: Ni or Ni and at least one transition metal element selected from the group consisting of Mg, Mn, Zn, Co and Al; and S, and an oxidation ratio is 80% or more.

In the aspect, when the hydroxide is oxidized to obtain the oxyhydroxide, the oxidation ratio of an oxidization step is 80% or more.

An aspect of the present disclosure is the positive electrode active material for sodium ion secondary batteries, wherein at least a portion of a surface of the oxyhydroxide is covered with a cobalt compound.

An aspect of the present disclosure is a positive electrode for sodium ion secondary batteries, comprising the positive electrode active material for sodium ion secondary batteries.

An aspect of the present disclosure is a sodium ion secondary battery comprising the positive electrode for sodium ion secondary batteries.

According to the aspect of the present disclosure, the positive electrode active material for sodium ion secondary batteries comprises the oxyhydroxide containing: Ni or Ni and at least one transition metal element selected from the group consisting of Mg, Mn, Zn, Co and Al; Na; and S, whereby the positive electrode active material for sodium ion secondary batteries having an excellent charge/discharge capacity can be obtained. A firing step is unnecessary in order to obtain the oxyhydroxide, whereby production costs can be reduced, and a production method can be simplified.

According to the aspect of the present disclosure, at least a portion of the surface of the oxyhydroxide is covered with the cobalt compound, whereby the charge/discharge capacity can be further increased.

### BRIEF DESCRIPTION OF THE DRAWINGS

FIG. 1 A view showing the evaluation results of a charge/discharge capacity.

FIG. 2 A view showing the X-ray diffraction patterns of positive electrode active material particles of Examples and Comparative Examples.

### DETAILED DESCRIPTION OF THE DISCLOSURE

A positive electrode active material for sodium ion secondary batteries of the present disclosure contains an oxyhydroxide containing: Ni or Ni and at least one transition metal element selected from the group consisting of Mg, Mn, Zn, Co and Al; Na; and S. The positive electrode active material for sodium ion secondary batteries of the present disclosure contains the oxyhydroxide as a main component. The oxyhydroxide is a particulate or powdered inorganic material, and has a generally spherical shape.

A sulfur element (S) contained in the oxyhydroxide is an inevitable impurity.

The content of the oxyhydroxide in the positive electrode active material for sodium ion secondary batteries is not particularly limited, but the content is preferably 50% by mass or more, more preferably 70% by mass or more, and particularly preferably 80% by mass or more, in light of reliably obtaining an excellent charge/discharge capacity. The positive electrode active material for sodium ion secondary batteries may contain the oxyhydroxide as an aspect, i.e., the content of the oxyhydroxide may be 100% by mass.

Examples of components other than the oxyhydroxide contained in the positive electrode active material for sodium ion secondary batteries include a hydroxide containing: at least one transition metal element selected from the group consisting of Mg, Mn, Zn, Co, Ni and Al; Na; and S, and an oxyhydroxide containing: at least one transition metal element selected from the group consisting of Mg, Mn, Zn, Co, Ni and Al; and S.

The transition metal element constituting the oxyhydroxide is not particularly limited as long as the transition metal element is Ni or Ni and at least one selected from the group consisting of Mg, Mn, Zn, Co and Al, but in light of reliably obtaining an excellent charge/discharge capacity, an aspect in which Co or Ni is contained is preferable, and an aspect in which Ni and Co are contained is more preferable. In light of further improving a charge/discharge capacity, an aspect in which Ni, Co and Mn are contained is more preferable, and in light of obtaining a further excellent charge/discharge capacity, an aspect in which Ni, Co, and Al are contained is particularly preferable. When Ni is contained as the transition metal element, or Ni and Co are contained, the content of Ni in the oxyhydroxide is not particularly limited, but the upper limit of the content is preferably 100.0 mol %, and particularly preferably 95.0 mol %. Meanwhile, the lower limit of the content is preferably 10.0 mol %, and particularly preferably 20.0 mol %. When Ni and Co are contained as the transition metal element, the content of Co in the oxyhydroxide is not particularly limited, but the upper limit of the content is preferably 40.0 mol %, and particularly preferably 35.0 mol %. Meanwhile, the lower limit of the content is preferably 1.0 mol %, and particularly preferably 5.0 mol %. The upper limit and the lower limit can be optionally combined.

The content of Na contained in the oxyhydroxide is not particularly limited, but for example, in light of reliably obtaining an excellent charge/discharge capacity, the upper limit of the content is preferably 2.0% by mass, and particularly preferably 1.5% by mass. Meanwhile, the lower limit of the content is preferably 0.1% by mass, and particularly preferably 0.2% by mass or less. The upper limit and the lower limit can be optionally combined.

The content of S as an inevitable impurity contained in the oxyhydroxide is not particularly limited, but for example, in light of reliably obtaining an excellent charge/discharge capacity, the content of S is preferably 0.4% by mass or less, more preferably 0.3% by mass or less, and particularly preferably 0.2% by mass. Since S is the inevitable impurity, 0.05% by mass or more of S is usually contained in the oxyhydroxide.

At least a portion of the surface of the oxyhydroxide may be covered with a cobalt compound if necessary. That is, oxyhydroxide particles covered with the cobalt compound may have a structure including a core of oxyhydroxide particles and a shell (covering layer) of the cobalt compound. The oxyhydroxide is covered with the cobalt compound, whereby the charge/discharge capacity can be further increased.

Examples of the cobalt compound include cobalt hydroxide, cobalt oxyhydroxide, and a mixture of cobalt hydroxide and cobalt oxyhydroxide. The rate of the mass of cobalt of the covering layer in the oxyhydroxide particles covered with the cobalt compound is not particularly limited. For example, in light of imparting conductivity while further improving a charge/discharge capacity, the upper limit of the rate is preferably 5.0% by mass, and particularly preferably 4.0% by mass. Meanwhile, the lower limit of the rate is preferably 1.0% by mass, and particularly preferably 2.0% by mass. The upper limit and the lower limit can be optionally combined.

The BET specific surface areas of the oxyhydroxide and oxyhydroxide covered with the cobalt compound are not particularly limited, but for example, in light of the balance between improvement in a density and securement of a contact surface with an electrolyte, the upper limit of the range is preferably 30.0 m²/g, and particularly preferably 20.0 m²/g. Meanwhile, the lower limit of the range is preferably 5.0 m²/g, and particularly preferably 10.0 m²/g. The upper limit and the lower limit can be optionally combined.

The particle size distributions of the oxyhydroxide and oxyhydroxide covered with the cobalt compound are not particularly limited, but for example, in light of the balance between improvement in a density and securement of a contact surface with an electrolyte, the upper limit of a secondary particle size D50 (hereinafter, also may be referred to as “D50”) in which the cumulative volume percent of the oxyhydroxide and oxyhydroxide covered with the cobalt compound are 50% by volume is preferably 15.0 μm, and particularly preferably 12.5 μm. Meanwhile, the lower limit of the secondary particle size D50 is preferably 4.0 μm, and particularly preferably 5.0 μm. The upper limit and the lower limit can be optionally combined.

The tap densities (hereinafter, also may be referred to as “TD”) of the oxyhydroxide and oxyhydroxide covered with the cobalt compound are not particularly limited, but for example, the value is preferably 1.5 g/cm³ or more, and particularly preferably 1.7 g/cm³ or more in light of improvement in a filling degree when used as a positive electrode active material.

The bulk densities (hereinafter, also may be referred to as “BD”) of the oxyhydroxide and oxyhydroxide covered with the cobalt compound are not particularly limited, but the value is preferably 0.8 g/cm³ or more, and particularly preferably 1.0 g/cm³ or more in light of improvement in a filling degree when used as a positive electrode active material.

Next, there will be described an example of a method of manufacturing the oxyhydroxide containing: Ni or Ni and at least one transition metal element selected from the group consisting of Mg, Mn, Zn, Co and Al; Na; and S, of the present disclosure.

First, according to a coprecipitation method, a salt solution (for example, sulfate solution) of Ni or Ni and at least one transition metal element selected from the group consisting of Mg, Mn, Zn, Co and Al is caused to react with a complexing agent, to manufacture a composite metal hydroxide. Water is used as a solvent.

The complexing agent is not particularly limited as long as the complexing agent can form a complex with ions of Ni and each of transition metal elements in an aqueous solution. Examples thereof include an ammonium ion donor (ammonium sulfate, ammonium chloride, ammonium carbonate, ammonium fluoride, or the like), hydrazine, ethylenediaminetetraacetic acid, nitrilotriacetic acid, uracil diacetate and glycine. For adjusting the pH value of the aqueous solution during the precipitation, if necessary, an alkali metal hydroxide (such as sodium hydroxide or potassium hydroxide) may be added.

When the complexing agent is continuously supplied to a reaction vessel in addition to the salt solution, Ni and each of the transition metal elements react, whereby a composite metal hydroxide is manufactured. While, during the reaction, the temperature of the reaction vessel is controlled within the range of, for example, 10° C. to 80° C., and preferably 20° C. to 70° C., and a pH value in the reaction vessel at 25° C. is controlled within the range of, for example, 9 to 13, and preferably 11 to 13, the substances in the reaction vessel are appropriately stirred. Examples of the reaction vessel include a continuous reaction vessel which overflows the formed composite metal hydroxide in order to separate the composite metal hydroxide.

The obtained composite metal hydroxide is washed with water, and then dried. The composite metal hydroxide may be washed with weak alkali water if necessary.

The composite metal hydroxide separated as described above is then subjected to an oxidation treatment using an oxidizing agent containing a Na source, whereby an oxyhydroxide can be obtained, which is a positive electrode active material for sodium ion secondary batteries, and contains: Ni or Ni and the transition metal element; Na; and S. Therefore, a firing step is not needed in order to obtain the oxyhydroxide. That is, after the salt solution (for example, sulfate solution) of Ni or Ni and the transition metal element is caused to react with the complexing agent, the oxyhydroxide can be manufactured according to a so-called wet step in which firing is not carried out. Therefore, the oxyhydroxide can reduce production costs, and provides an easy production method.

When the composite metal hydroxide is fired after the sodium source is added, a metal oxide represented by NaMeO₂ is considered to be obtained. Me in the formula means Ni or Ni and at least one transition metal element selected from the group consisting of Mg, Mn, Zn, Co and Al.

Examples of the oxidizing agent include sodium salts of hypochlorous acid, persulfate, and chlorous acid or the like. For example, sodium hypochlorite to be used can function as the oxidizing agent and the Na source.

The oxidation ratio of the composite metal hydroxide is not particularly limited, but the oxidation ratio is preferably 50% or more, more preferably 70% or more, and particularly preferably 80% or more in light of reliably obtaining an excellent charge/discharge capacity.

In order to cover composite metal hydroxide particles which are the precursors of the oxyhydroxide particles with the cobalt compound to obtain the composite metal hydroxide covered with the cobalt compound, to a suspension of the composite metal hydroxide particles, a cobalt salt solution (for example, an aqueous solution of cobalt sulfate or the like) and an alkaline solution (for example, an aqueous sodium hydroxide solution or the like) are added while being stirred, whereby a covering containing a cobalt compound in which the valence of cobalt is 2 such as cobalt hydroxide as a main component is formed on the surface of the composite metal hydroxide particles according to neutralization crystallization. The pH of a step of forming the covering is preferably maintained in the range of 9 to 13 at 25° C.

The composite metal hydroxide particles covered with the cobalt compound on which the covering of the cobalt compound in which the valence of cobalt is 2 such as cobalt hydroxide is formed are subjected to an oxidation treatment, whereby a covering containing a cobalt compound in which the valence of cobalt is 3 (for example, cobalt oxyhydroxide or the like) as a main component can be formed.

Examples of the method of the oxidation treatment include a method of continuously supplying oxygen while stirring a suspension of composite metal hydroxide particles on which a covering of a cobalt compound in which the valence of cobalt is 2 is formed, a method of subjecting the composite metal hydroxide particles on which a covering of a cobalt compound in which the valence of cobalt is 2 is formed to electric oxidization in an acid electrolyte aqueous solution, a method of adding an oxidizing agent (sodium hypochlorite or the like) while stirring a suspension of composite metal hydroxide particles on which a covering of a cobalt compound in which the valence of cobalt is 2 is formed, to oxidize the composite metal hydroxide particles, and a method of adding sodium hydroxide or the like to composite metal hydroxide particles on which a covering of a cobalt compound in which the valence of cobalt is 2 is formed, to heat and oxidize the composite metal hydroxide particles.

Next, a positive electrode comprising the positive electrode active material of the present disclosure and a sodium ion secondary battery comprising the positive electrode will be described. The sodium ion secondary battery includes the positive electrode using the above-described positive electrode active material of the present disclosure, a negative electrode, an electrolyte, and a separator.

The positive electrode includes a positive electrode current collector and a positive electrode active material layer formed on the surface of the positive electrode current collector. The positive electrode active material layer contains the positive electrode active material, a conductive auxiliary agent, and a binder. Examples of the conductive auxiliary agent include carbonaceous materials such as natural graphite, artificial graphite, coke, and carbon black. Examples of the binder include PVdF (polyvinylidene fluoride), polycarboxylic acid, and a polycarboxylic acid alkali metal salt. Examples of the positive electrode current collector include a foil body and a mesh containing a conductive metal material such as nickel, aluminum, or stainless steel.

As a method of manufacturing the positive electrode, for example, first, a positive electrode active material, a conductive material, a binder, and water are mixed, to prepare a positive electrode active material slurry. Then, the positive electrode active material slurry is coated on the positive electrode current collector according to known coating methods such as a screen printing method, to form a coated film. The coated film is dried, and then firmly fixed by a press or the like.

The negative electrode includes a negative electrode current collector and a negative electrode active material layer formed on the surface of the negative electrode current collector. The negative electrode active material layer contains a negative electrode active material and a binder. Examples of the negative electrode active material include carbonaceous materials capable of storing and releasing sodium such as natural graphite, artificial graphite, coke, carbon black, and carbon fiber. Examples of the binder include polyvinylidene fluoride (PVDF), polytetrafluoroethylene (PTFE), ethylene tetrafluoride-propylene hexafluoride-vinylidene fluoride-based copolymer, propylene hexafluoride-vinylidene fluoride-based copolymer, and ethylene tetrafluoride-perfluorovinyl ether-based copolymer. Examples of the negative electrode current collector include a foil body and a mesh containing a conductive metal material such as nickel, aluminum, or stainless steel.

Examples of a method of manufacturing the negative electrode include the same method as the method of manufacturing the positive electrode.

Examples of the electrolyte are not particularly limited and include an electrolytic solution and a solid electrolyte which are usually used. Examples of the electrolytic solution include carbonates such as propylene carbonate, ethylene carbonate, dimethyl carbonate, diethyl carbonate, ethyl methyl carbonate, isopropyl methyl carbonate, vinylene carbonate, fluoroethylene carbonate, 4-trifluoromethyl-1,3-dioxolan-2-one, and 1,2-di(methoxycarbonyloxy)ethane; ethers such as 1,2-dimethoxyethane, 1,3-dimethoxypropane, pentafluoropropyl methyl ether, 2,2,3,3-tetrafluoropropyl difluoromethyl ether, tetrahydrofuran, and 2-methyltetrahydrofuran; esters such as methyl formate, methyl acetate, and γ-butyrolactone; nitrites such as acetonitrile and butyronitrile; amides such as N,N-dimethylformamide, and N,N-dimethylacetamide; carbamates such as 3-methyl-2-oxazolidone; and sulfur-containing compounds such as sulfolane. These may be used alone, or may be mixed in combination of two or more.

Examples of the solid electrolyte include a polyethylene oxide-based polymer compound, an organic solid electrolyte such as a polymer compound containing at least one or more of polyorganosiloxane chains and polyoxyalkylene chains, and a gel-like polymer compound holding a nonaqueous electrolyte solution. Another examples thereof include sulfide-based and oxide-based inorganic solid electrolytes. These may be used alone, or two or more of them may be mixed to be used.

Examples of the separator include separators made of a polyolefin resin, a fluorine resin, nylon, and aromatic aramid, and examples of the form include a laminated film, a porous film, a nonwoven fabric, and a woven fabric.

Next, Examples of the present disclosure will be described, but the present disclosure is not limited to these examples as long as the gist of the present disclosure is not deviated from.

### Example 1

Synthesis of Oxyhydroxide Particles Containing: Transition Metal Element Consisting of Zn, Co and Ni; Na; and S

An aqueous ammonium sulfate solution (complexing agent) and an aqueous sodium hydroxide solution were dropped to an aqueous solution in which zinc sulfate, cobalt sulfate, and nickel sulfate were dissolved so that Zn:Co:Ni=6.6:1.1:92.3 (mol %), and these were continuously stirred with a stirrer while pH in a reaction vessel at 25° C. was maintained at 12.0. The generated hydroxide was made to overflow from an overflow pipe of the reaction vessel, and was taken out. The taken-out hydroxide was subjected to each of water washing, dehydrating, and drying processes, to obtain composite metal hydroxide particles containing Zn, Co, and Ni which were precursors of oxyhydroxide particles containing: a transition metal element consisting of Zn, Co, and Ni; and S.

The composite metal hydroxide particles obtained as described above and containing Zn, Co, and Ni were placed in a reaction bath containing water, to obtain a suspension of the composite metal hydroxide particles. While stirring the suspension, 0.67 L of a sodium hypochlorite solution having a chlorine concentration of 14% by mass was added to 100 g of the composite metal hydroxide particles, to subject the composite metal hydroxide particles to an oxidation treatment, and sodium was supplied to obtain a suspension of the oxyhydroxide particles containing: a transition metal element consisting of Zn, Co, and Ni; Na; and S. The obtained suspension of the oxyhydroxide particles was subjected to each of water washing, dehydrating, and drying processes, to obtain oxyhydroxide particles containing: a transition metal element consisting of Zn, Co, and Ni; Na; and S. The composition of the obtained oxyhydroxide particles contained zinc, cobalt, and nickel (mol %) shown in the following Table 1.

### Example 2

Synthesis of Oxyhydroxide Particles Covered with Cobalt Compound, and Containing: Transition Metal Element Consisting of Zn, Co, and Ni; Na; and S

The composite metal hydroxide particles containing Zn, Co, and Ni which were the precursors of the oxyhydroxide particles of Example 1 obtained as described above were introduced to an alkaline aqueous solution in a reaction bath in which pH at 25° C. was maintained in a range of 9 to 13 by sodium hydroxide. After the introduction, while stirring the solution, a cobalt sulfate aqueous solution having a concentration of 90 g/L was dropped. In the meantime, an aqueous sodium hydroxide solution was appropriately dropped, and pH in the reaction bath at 25° C. was maintained in the range of 9 to 13 to form a covering layer of cobalt hydroxide on the surface of the composite metal hydroxide particles, thereby obtaining a suspension of the composite metal hydroxide particles covered with cobalt hydroxide, and containing: a transition metal element consisting of Zn, Co, and Ni; and S. The obtained suspension of the composite metal hydroxide particles was subjected to each of water washing, dehydrating, and drying processes, to obtain composite metal hydroxide particles covered with cobalt hydroxide and containing: a transition metal element consisting of Zn, Co, and Ni; and S. The composite metal hydroxide particles thus obtained, including the covering of cobalt hydroxide formed thereon, and containing Zn, Co, and Ni were placed in a reaction bath containing water, to obtain a suspension of the composite metal hydroxide particles. While stirring the suspension, 0.67 L of a sodium hypochlorite solution having a chlorine concentration of 14% by mass was added to 100 g of the composite metal hydroxide particles, to subject the composite metal hydroxide particles to an oxidation treatment, and sodium was supplied to obtain a suspension of the oxyhydroxide particles including the covering of the cobalt compound formed thereon and containing: a transition metal element consisting of Zn, Co, and Ni; Na; and S. The obtained suspension of the oxyhydroxide particles was subjected to each of water washing, dehydrating, and drying processes, to obtain oxyhydroxide particles including the covering of the cobalt compound formed thereon and containing: a transition metal element consisting of Zn, Co, and Ni; Na; and S. The composition of the obtained oxyhydroxide particles covered with the cobalt compound contained zinc, cobalt, and nickel (mol %) shown in the following Table 1.

### Example 3

Synthesis of Oxyhydroxide Particles Containing: Transition Metal Element Consisting of Mg, Zn, Co, and Ni; Na; and S

Oxyhydroxide particles containing: a transition metal element consisting of Mg, Zn, Co, and Ni; Na; and S, were obtained in the same manner as in Example 1 except that an aqueous solution was used, in which magnesium sulfate, zinc sulfate, cobalt sulfate, and nickel sulfate were dissolved so that Mg:Zn:Co:Ni=1.9:5.8:1.1:91.2 (mol %). The composition of the obtained oxyhydroxide particles contained magnesium, zinc, cobalt, and nickel (mol %) shown in the following Table 1.

### Example 4

Synthesis of Oxyhydroxide Particles Covered with Cobalt Compound, and Containing: Transition Metal Element Consisting of Mg, Zn, Co, and Ni; Na; and S

The composite metal hydroxide which was obtained in Example 3, which was a precursor of oxyhydroxide particles containing: a transition metal element consisting of Mg, Zn, Co, and Ni; Na; and S, and contained Mg, Zn, Co, and Ni, was introduced to an alkaline aqueous solution in a reaction bath in which pH at 25° C. was maintained in a range of 9 to 13 by sodium hydroxide. After the introduction, while stirring the solution, a cobalt sulfate aqueous solution having a concentration of 90 g/L was dropped. In the meantime, an aqueous sodium hydroxide solution was appropriately dropped, and pH in the reaction bath at 25° C. was maintained in the range of 9 to 13 to form a covering layer of cobalt hydroxide on the surface of the composite metal hydroxide particles, thereby obtaining a suspension of the composite metal hydroxide particles covered with cobalt hydroxide, and containing: a transition metal element consisting of Mg, Zn, Co, and Ni; and S. The obtained suspension of the composite metal hydroxide particles was subjected to each of water washing, dehydrating, and drying processes, to obtain composite metal hydroxide particles covered with cobalt hydroxide and containing: a transition metal element consisting of Mg, Zn, Co, and Ni; and S. The composite metal hydroxide particles thus obtained, including the covering of cobalt hydroxide formed thereon, and containing Mg, Zn, Co, and Ni were placed in a reaction bath containing water, to obtain a suspension of the composite metal hydroxide particles. While stirring the suspension, 0.67 L of a sodium hypochlorite solution having a chlorine concentration of 14% by mass was added to 100 g of the composite metal hydroxide particles, to subject the composite metal hydroxide particles to an oxidation treatment, and sodium was supplied to obtain a suspension of the oxyhydroxide particles including the covering of the cobalt compound formed thereon and containing: a transition metal element consisting of Mg, Zn, Co, and Ni; Na; and S. The obtained suspension of the composite metal hydroxide particles was subjected to each of water washing, dehydrating, and drying processes, to obtain oxyhydroxide particles including the covering of the cobalt compound formed thereon, and containing: a transition metal element consisting of Mg, Zn, Co, and Ni; Na; and S. The composition of the obtained oxyhydroxide particles covered with the cobalt compound contained magnesium, zinc, cobalt, and nickel (mol %) shown in the following Table 1.

### Example 5

Synthesis of Oxyhydroxide Particles Containing: Transition Metal Element Consisting of Mn, Co, and Ni; Na; and S

Oxyhydroxide particles containing: a transition metal element consisting of Mn, Co, and Ni; Na; and S, were obtained in the same manner as in Example 1 except that an aqueous solution was used, in which manganese sulfate, cobalt sulfate, and nickel sulfate were dissolved so that Mn:Co:Ni=33.3:33.2:33.5 (mol %). The composition of the obtained oxyhydroxide particles contained manganese, cobalt, and nickel (mol %) shown in the following Table 1.

### Example 6

Synthesis of Oxyhydroxide Particles Covered with Cobalt Compound and Containing: Transition Metal Element Consisting of Mn, Co, and Ni; Na; and S

Composite metal hydroxide particles which were precursors of oxyhydroxide particles containing: a transition metal element consisting of Mn, Co, and Ni; and S, and contained Mn, Co, and Ni, were obtained in the same manner as in Example 1 except that an aqueous solution was used, in which manganese sulfate, cobalt sulfate, and nickel sulfate were dissolved so that Mn:Co:Ni=35.2:33.3:31.5 (mol %).

The composite metal hydroxide which was obtained as described above, which was a precursor of the oxyhydroxide particles containing: a transition metal element consisting of Mn, Co, and Ni; Na; and S, and contained Mn, Co, and Ni, was introduced to an alkaline aqueous solution in a reaction bath in which pH at 25° C. was maintained in a range of 9 to 13 by sodium hydroxide. After the introduction, while stirring the solution, a cobalt sulfate aqueous solution having a concentration of 90 g/L was dropped. In the meantime, an aqueous sodium hydroxide solution was appropriately dropped, and pH in the reaction bath at 25° C. was maintained in the range of 9 to 13 to form a covering layer of cobalt hydroxide on the surface of the composite metal hydroxide particles, thereby obtaining a suspension of the composite metal hydroxide particles covered with cobalt hydroxide, and containing: a transition metal element consisting of Mn, Co, and Ni; and S. The obtained suspension of the composite metal hydroxide particles was subjected to each of water washing, dehydrating, and drying processes, to obtain composite metal hydroxide particles covered with cobalt hydroxide and containing: a transition metal element consisting of Mn, Co, and Ni; and S. The composite metal hydroxide particles thus obtained, covered with cobalt hydroxide, and containing Mn, Co, and Ni were placed in a reaction bath containing water, to obtain a suspension of the composite metal hydroxide particles. While stirring the suspension, 0.80 L of a sodium hypochlorite solution having a chlorine concentration of 14% by mass was added to 100 g of the composite metal hydroxide particles, to subject the composite metal hydroxide particles to an oxidation treatment, and sodium was supplied to obtain a suspension of the oxyhydroxide particles including the covering of the cobalt compound formed thereon and containing: a transition metal element consisting of Mn, Co, and Ni; Na; and S. The obtained suspension of the oxyhydroxide particles was subjected to each of water washing, dehydrating, and drying processes, to obtain oxyhydroxide particles including the covering of the cobalt compound formed thereon and containing a transition metal element consisting of Mn, Co, and Ni; Na; and S. The composition of the obtained oxyhydroxide particles covered with the cobalt compound contained manganese, cobalt, and nickel (mol %) shown in the following Table 1.

### Example 7

Synthesis of Oxyhydroxide Particles Containing: Transition Metal Element Consisting of Al, Co, and Ni; Na; and S

Oxyhydroxide particles containing: a transition metal element consisting of Al, Co, and Ni; Na; and S, were obtained in the same manner as in Example 1 except that an aqueous solution was used, in which aluminum sulfate, cobalt sulfate, and nickel sulfate were dissolved so that Al:Co:Ni=3.5:9.3:87.2 (mol %). The composition of the obtained oxyhydroxide particles contained aluminum, cobalt, and nickel (mol %) shown in the following Table 1.

### Comparative Example 1

Synthesis of Hydroxide Particles of Transition Metal Element Consisting of Mn, Co, and Ni

Hydroxide particles of a transition metal element consisting of Mn, Co, and Ni were obtained in the same manner as in Example 5 except that sodium hypochlorite was not added. The composition of the obtained hydroxide particles contained manganese, cobalt, and nickel (mol %) shown in the following Table 1.

Production of Positive Electrode Plate

A positive electrode active material, carbon black, and PVdF were added to a dispersing agent (N-methyl-2-pyrrolidone) so that particles of each Example or Comparative Example as a positive electrode active material : carbon black as a conductive auxiliary agent : PVdF (polyvinylidene fluoride) as a binder=85:10:5 in a solid content mass ratio, followed by mixing to produce a slurry-like composition. Each of positive electrode plates was produced by applying the produced slurry-like composition to an aluminum foil (current collector), followed by drying and then rolling.

### Production of Evaluation Cell

A CR2032 type coin battery (sodium-ion secondary battery) was produced with each of the above positive electrode plates, a sodium metal for an opposite pole, a polypropylene (PP)/polyethylene (PE)/polypropylene (PP) laminated film as a separator, and an electrolytic solution in which a supporting electrolyte (1 mol/L-NaPF₆) was dissolved in a solvent in which ethylene carbonate (EC) and diethyl carbonate (DEC) were mixed at a volume ratio of 1:1.

The physical properties of the oxyhydroxide particles of Examples 1 to 7 and the hydroxide particles of Comparative Example 1 are shown in the following Table 1.

TABLE 1

| | | | | | | | | | Comparative |
|---|---|---|---|---|---|---|---|---|---|
| | | Ex 1 | Ex 2 | Ex 3 | Ex 4 | Ex 5 | Ex 6 | Ex 7 | Example 1 |
| Ni | % by mass | 57.5 | 53.8 | 56.6 | 54.6 | 21.0 | 19.0 | 53.5 | 20.9 |
| Co | % by mass | 0.7 | 3.9 | 0.7 | 3.3 | 20.9 | 22.6 | 5.7 | 21.1 |
| Covering | % by mass | — | 3.2 | — | 2.6 | — | 2.4 | — | — |
| Co | | | | | | | | | |
| Zn | % by mass | 4.6 | 4.2 | 4.0 | 3.8 | — | — | — | — |
| Mg | % by mass | — | — | 0.5 | 0.5 | — | — | — | — |
| Mn | % by mass | — | — | — | — | 19.5 | 19.9 | — | 19.6 |
| Al | % by mass | — | — | — | — | — | — | 1.0 | — |
| Ni | mol % | 92.3 | 87.5 | 91.2 | 87.3 | 33.5 | 30.2 | 87.2 | 33.3 |
| Co | mol % | 1.1 | 6.3 | 1.1 | 5.3 | 33.2 | 35.9 | 9.3 | 33.4 |
| Zn | mol % | 6.6 | 6.2 | 5.8 | 5.5 | — | — | — | — |
| Mg | mol % | — | — | 1.9 | 1.9 | — | — | — | — |
| Mn | mol % | — | — | — | — | 33.3 | 33.9 | — | 33.3 |
| Al | mol % | — | — | — | — | — | — | 3.5 | — |
| Na | % by mass | 0.51 | 0.42 | 0.83 | 0.87 | 0.24 | 0.47 | 0.91 | — |
| S | % by mass | 0.09 | 0.10 | 0.08 | 0.09 | 0.19 | 0.12 | 0.11 | 0.21 |
| BET | m²/g | 10.8 | 14.1 | 19.0 | 15.1 | 11.3 | 18.1 | 32.7 | 12.0 |
| D5O | μm | 12.5 | 12.0 | 11.1 | 10.7 | 8.8 | 5.6 | 12.4 | 9.0 |
| TD | g/cm³ | 2.23 | 2.14 | 2.22 | 2.21 | 2.22 | 1.69 | 2.01 | 2.21 |
| BD | g/cm³ | 1.73 | 1.53 | 1.59 | 1.63 | 1.64 | 1.11 | 1.61 | 1.67 |
| Oxidation | % | 91.5 | 91.7 | 90.0 | 92.4 | 99.2 | 100.0 | 99.5 | — |
| ratio | | | | | | | | | |
| Discharge | mAh/g | 32 | 73 | 29 | 36 | 41 | 58 | 90 | 23 |
| capacity | | | | | | | | | |

The sign “-” in Table 1 means no blending or no implementation.

In Table 1, the compositions of the transition metal element, Na, and S were analyzed using an ICP emission spectrometer (Optima (registered trademark) 8300 manufactured by PerkinElmer, Inc.). A value obtained by deducting the Co content of the composite metal hydroxide from the Co content of the oxyhydroxide covered with the cobalt compound was taken as the Co content of the covering.

The BET specific surface area was measured according to a one-point BET method by using a surface area measuring device (Macsorb (registered trademark) manufactured by Mountech Co., Ltd.).

D50 was measured with a particle size distribution measuring device (LA-950 manufactured by Horiba, Ltd.) (the principle was based on a laser diffraction-scattering method).

The tap density (TD) was measured with a constant-volume measuring method in techniques described in JIS R1628-1997 by using a tap denser (KYT-4000 manufactured by Seishin Enterprise Co., Ltd.). Specifically, the tap density was calculated by covering a container for measurement in a state where the container was filled with a measurement sample as described above, repeating tapping 200 times by a stroke length of 50 mm, and thereafter reading a sample capacity.

A sample was caused to free-fall to fill a container with the sample, and the bulk density (BD) was measured from the volume of the container and the mass of the sample. Specifically, a measurement sample was caused to free-fall through a sieve to fill a container for measurement of 20 crrOwith the measurement sample. A sample weight at that time was measured to calculate the bulk density.

An oxidation ratio was calculated by totally dissolving the sample using sulfuric acid, then performing measurement according to redox titration using potassium permanganate, and taking a case where all metals other than Na, S and Al became trivalent as 100%.

X diffraction measurement was performed under the following conditions using an X-ray diffraction device (Ultima IV manufactured by Rigaku Corporation).
X-rays: CuKα/40 kV/40 mA
Slit: divergence=1/2°, light-receiving =opening, scattering=8.0 mm
Sampling width: 0.03
Scanning speed: 20°/min

Conditions of Charge/Discharge Capacity Tests of Cells

Each of the batteries produced according to the above step was charged and discharged at a constant current at a load current of 6 mA/g (positive electrode active material) in a voltage range of 1.5 V or more and 4.5 V or less at a temperature of 25° C.

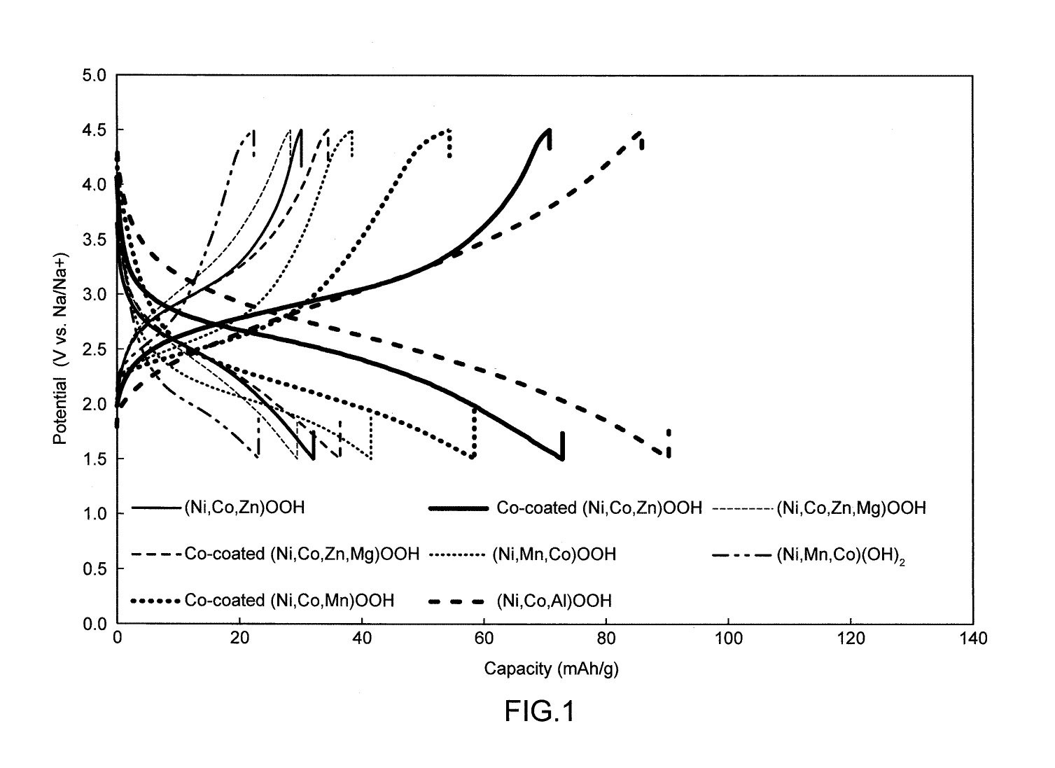

The results of the charge/discharge capacity tests are shown in FIG. 1. In the formulae of Examples described in FIG. 1, the description of a Na element was omitted.

Regarding Identification of Oxyhydroxide

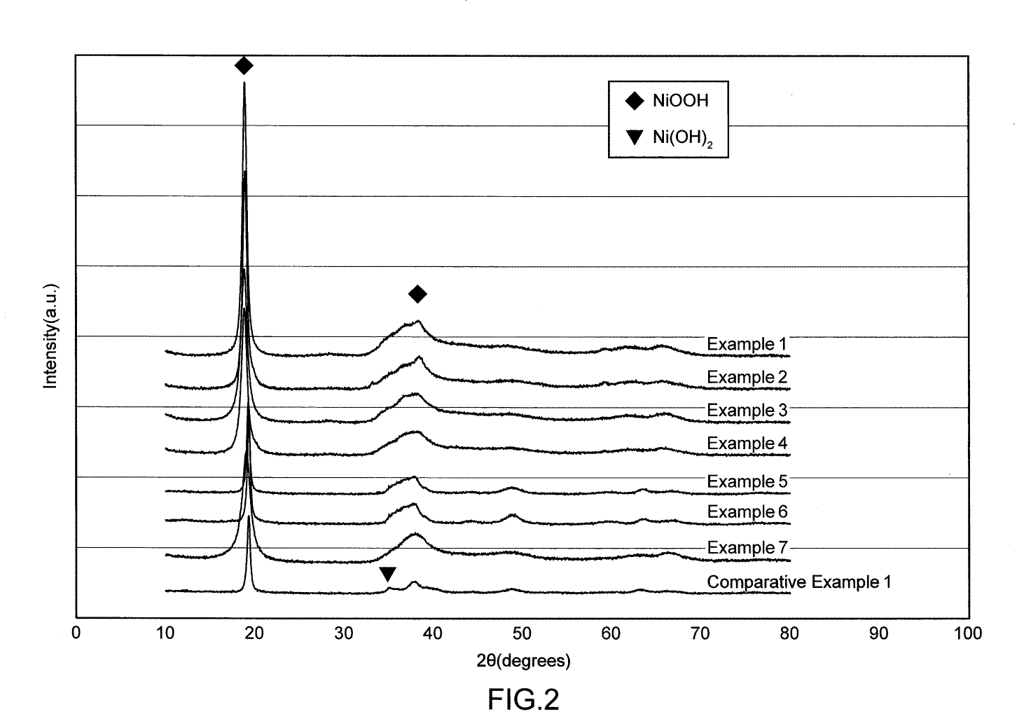

X-ray diffraction patterns obtained by subjecting the particles obtained in Examples 1 to 7 and Comparative Example 1 to X-ray diffraction analysis are shown in FIG. 2.

As shown in FIG. 2, the peak of the oxyhydroxide was obtained in Examples 1 to 7, and by contrast, the peak of the hydroxide was obtained in Comparative Example 1. From FIG. 1, the oxyhydroxide of Examples 1 to 7 could provide a superior electric discharge capacity (29 mAh/g or more) than that of the hydroxide of Comparative Example 1. From the comparisons of Examples 1 and 2, Examples 3 and 4, and Examples 5 and 6, the oxyhydroxide covered with the cobalt compound provided a further improved discharge capacity. From Examples 1, 3, 5, and 7, Example 5 containing a transition metal element consisting of Mn, Co, and Ni (molar ratio of Mn:Co:Ni=33.3:33.2:33.5) provided a further improved discharge capacity as compared with Example 1 containing a transition metal element consisting of Zn, Co, and Ni (molar ratio of Zn:Co:Ni=6.6:1.1:92.3) and Example 3 containing a transition metal element consisting of Mg, Zn, Co, and Ni (molar ratio of Mg:Zn:Co:Ni=1.9:5.8:1.1:91.2). Example 7 containing a transition metal element consisting of Al, Co, and Ni (molar ratio of Al:Co:Ni=3.5:9.3:87.2) provided a still further improved discharge capacity as compared with Example 5 containing a transition metal element consisting of Mn, Co, and Ni (molar ratio of Mn:Co:Ni=33.3:33.2:33.5). Therefore, in Examples 1, 3, 5, and 7 of the oxyhydroxide which was not covered with the cobalt compound, Example 7 containing a transition metal element consisting of Al, Co, and Ni could provide a particularly excellent discharge capacity.

Meanwhile, Comparative Example 1 in which the obtained hydroxide particles were not subjected to an oxidation treatment by addition of sodium hypochlorite, and a sodium source was not supplied had a discharge capacity of about 23 mAh/g, which was not good.

An oxyhydroxide containing: Ni or Ni and at least one transition metal element selected from the group consisting of Mg, Mn, Zn, Co and Al; Na; and S, of the present disclosure has an excellent charge/discharge capacity and can reduce production costs while being produced by an easy method, whereby the oxyhydroxide has a high utility value in the field of a positive electrode active material of a secondary battery, particularly the field of a positive electrode active material for sodium ion secondary batteries.

1. A positive electrode active material for sodium ion secondary batteries, comprising an oxyhydroxide, wherein the oxyhydroxide comprises:
Ni; or
Ni and at least one transition metal element selected from the group consisting of Mg, Mn, Zn, Co and Al; Na; and S.

2. The positive electrode active material for sodium ion secondary batteries according to claim 1, comprising a content of S from 0.05 to 0.4% by mass.

3. The positive electrode active material for sodium ion secondary batteries according to claim 1, comprising 80% by mass or more of the oxyhydroxide.

4. The positive electrode active material for sodium ion secondary batteries according to claim 1, wherein the oxyhydroxide has an oxidation ratio of 80% or more.

5. The positive electrode active material for sodium ion secondary batteries according to claim 1, wherein at least a portion of a surface of the oxyhydroxide is covered with a cobalt compound.

6. A positive electrode for sodium ion secondary batteries, comprising the positive electrode active material for sodium ion secondary batteries according to claim 1.

7. A sodium ion secondary battery comprising the positive electrode for sodium ion secondary batteries according to claim 6.
